(19) United States
(12) Patent Application Publication
(10) Pub. No.: US 2013/0192952 A1
(43) Pub. Date: Aug. 1, 2013

(54) PROFILE TRACK INTEGRATED DRIVE SYSTEM

(71) Applicants: Guobin Lin, Guangdong (CN); Zhaohui Lui, Guangdong (CN); Ke Ye, Guangdong (CN); Songjian He, Guangdong (CN); Biao Li, Guangdong (CN); Coliu Muke Wu, Guangdong (CN); Yanying Anne Chen, Guangdong (CN); Richard Qingdong Jiang, Guangdong (CN); Ji An Wan, Guangzhou AV (CN); Yaoji Xu, Guangdong (CN); Guojie Samuel Ye, Guangdong (CN); De Wu, Hangzhou (CN); MingPing Jiang, Zhejang (CN); JianGuo Li, ZheJiang (CN); Weifeng Shao, Zhejang (CN); Wei Ge, Zhejiang (CN); Graham Worthington, Ingleburn (AU)

(72) Inventors: Guobin Lin, Guangdong (CN); Zhaohui Lui, Guangdong (CN); Ke Ye, Guangdong (CN); Songjian He, Guangdong (CN); Biao Li, Guangdong (CN); Coliu Muke Wu, Guangdong (CN); Yanying Anne Chen, Guangdong (CN); Richard Qingdong Jiang, Guangdong (CN); Ji An Wan, Guangzhou AV (CN); Yaoji Xu, Guangdong (CN); Guojie Samuel Ye, Guangdong (CN); De Wu, Hangzhou (CN); MingPing Jiang, Zhejang (CN); JianGuo Li, ZheJiang (CN); Weifeng Shao, Zhejang (CN); Wei Ge, Zhejiang (CN); Graham Worthington, Ingleburn (AU)

(73) Assignee: OTIS ELEVATOR COMPANY, Farmington, CT (US)

(21) Appl. No.: 13/518,511

(22) PCT Filed: Dec. 23, 2010
(86) PCT No.: PCT/US10/61986

§ 371 Date: Oct. 17, 2012

(30) Foreign Application Priority Data
Dec. 23, 2009 (CN) 2009103120625

(51) Int. Cl. B66B 23/02

(52) U.S. Cl. CPC B66B 23/02
USPC 198/330; 29/428; 29/525.01

(57) ABSTRACT

A method for assembling a drive system for an escalator system includes securing one or more track sets extending along a path of the escalator to one or more support members extending at least partially across a width of the escalator system. A drive member is secured to the one or more support members such that the drive member is operably connected to the one or more track sets. The one or more track sets, the one or more support members and the drive member are installed into the escalator system as a unit.

### BACKGROUND OF THE INVENTION

The subject matter disclosed herein relates to escalators, travelators, moving ramps, and the like. More specifically, the subject disclosure relates to assembly and installation of escalators, travelators, moving ramps, and the like.

Escalator systems and the like typically include a number of tracks and track holders to guide a plurality of pallets along a desired path, whether it be between two levels as in the case of an escalator or moving ramp, or whether it is along a surface such as a floor as in the case of a moving walkway. Further, the systems typically include main drives which drive the pallets along the tracks, and handrail drives which drive handrails which are included in the system. These components, as well as many others, are installed into a truss or a steel plate structure that forms a support structure for, for example, the upper and lower landing of the escalator. In a typical assembly, the tracks, drives, etc. are individually installed into the truss and welded or otherwise affixed to the truss. This method of assembly is labor intensive and time consuming and access to assemble the parts to the truss structure is limited because of the truss.

### BRIEF DESCRIPTION OF THE INVENTION

According to one aspect of the invention, a method for assembling a drive system for an escalator system includes securing one or more track sets extending along a path of the escalator to one or more support members extending at least partially across a width of the escalator system. A drive member is secured to the one or more support members such that the drive member is operably connected to the one or more track sets. The one or more track sets, the one or more support members and the drive member are installed into the escalator system as a unit.

According to another aspect of the invention, an escalator drive system includes one or more track sets extending along a path of an escalator system. A drive member operably connected to the one or more track sets. One or more support members extend at least partially across a width of the escalator system and are secured to the one or more track sets and/or the drive member, such that the one or more track sets, the one or more support members and the drive member are installable into the escalator system as a unit.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of an embodiment of an escalator system;

FIG. 2 is a schematic view of an embodiment of a lower track set installed to a plurality of lower support brackets;

FIG. 3 is a schematic view of view of an embodiment of a lower landing assembly for an escalator system;

FIG. 4 is a schematic view of another embodiment of a lower track set installed to a plurality of lower support brackets;

FIG. 5 is a side view of the embodiment of FIG. 4 of a lower track set installed to a plurality of lower support brackets;

FIG. 6 is another schematic view of an embodiment of a lower landing assembly for an escalator system;

FIG. 7 is a schematic view of an upper track set installed to a plurality of upper support brackets;

FIG. 8 is a schematic view of an embodiment of an upper landing assembly for an escalator system;

FIG. 9 is a schematic view of another embodiment of an upper track set installed to a plurality of upper support brackets;

FIG. 10 is a side view of an embodiment of an upper track set installed to a plurality of upper support brackets; and

FIG. 11 is another schematic view of an embodiment of an upper landing assembly for an escalator system.

The detailed description explains embodiments of the invention, together with advantages and features, by way of example with reference to the drawings.

### DETAILED DESCRIPTION OF THE INVENTION

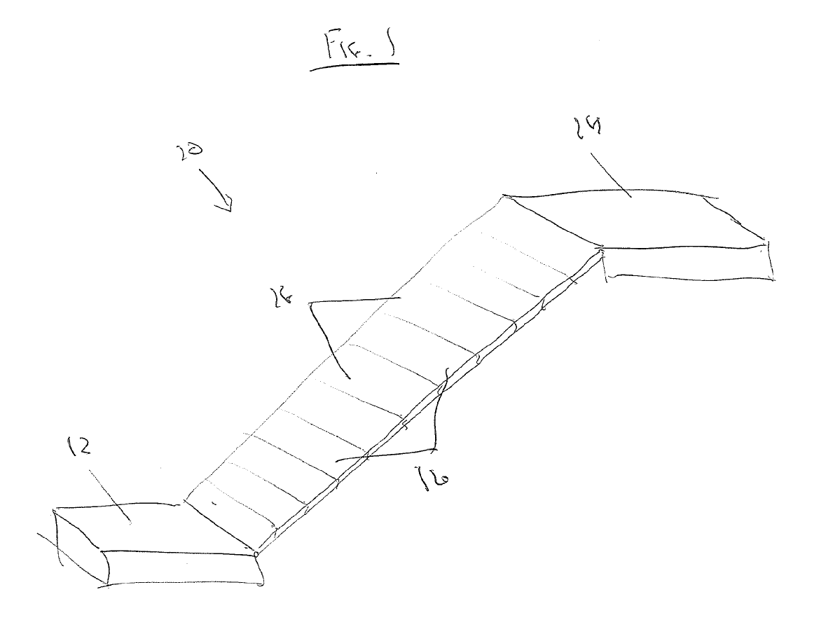

Shown in FIG. 1 is a schematic of an escalator assembly system 10. It is to be appreciated that while an escalator system 10 is depicted and described herein, the disclosed invention is applicable to similar devices such as moving ramps and travelators. The escalator system 10 includes a lower landing assembly 12 and an upper landing assembly 14, which define the ends of a path over which a plurality of pallets 16 are driven.

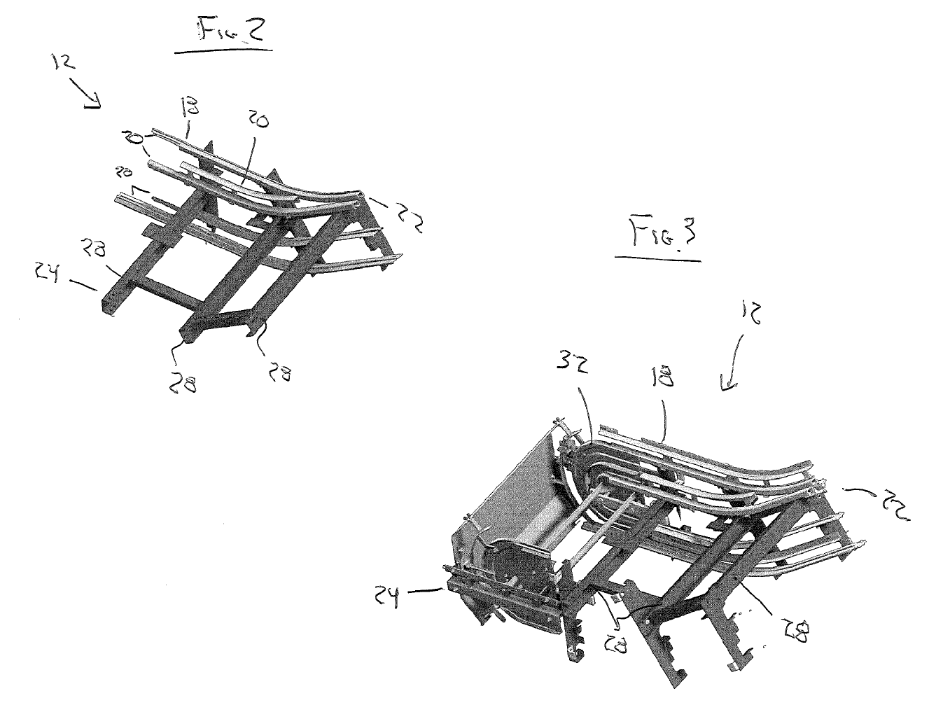

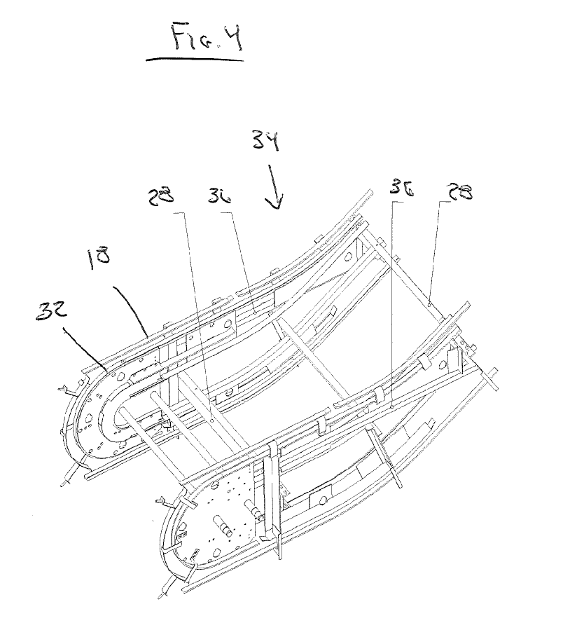

Referring to FIG. 2, shown are the components of a lower landing assembly 12. The lower landing assembly 12 includes a lower track set 18 made up of a plurality of individual lower profile tracks 20 to guide the plurality of pallets 16 (shown in FIG. 1). It is to be appreciated that while a single lower track set 18 is shown and is disposed at a first lateral side 22 of the lower landing assembly 12, in many embodiments another lower track set 18 is disposed at a second lateral side 24 of the lower landing assembly 12, but it is not shown herein for simplicity of illustration. The lower profile tracks 20 are secured to one or more lower support brackets 28 by, for example, threaded mechanical fasteners, such as bolts (not shown). The lower support brackets 28 span from the first lateral side 22 to the second lateral side 24 such that both lower track sets 18 are affixed to the lower support brackets 28 and accurately positioned relative to each other. Referring now to FIG. 3, the lower landing assembly 12 further includes a drive member, for example, a lower tension carriage 32, to maintain proper tension on the plurality of pallets 16. The lower tension carriage 32 is aligned to the lower track sets 18 and secured to the lower support brackets 28 such that the lower track sets 18, lower support brackets 28 and the lower tension carriage 32 form a single unitary lower landing assembly 12.

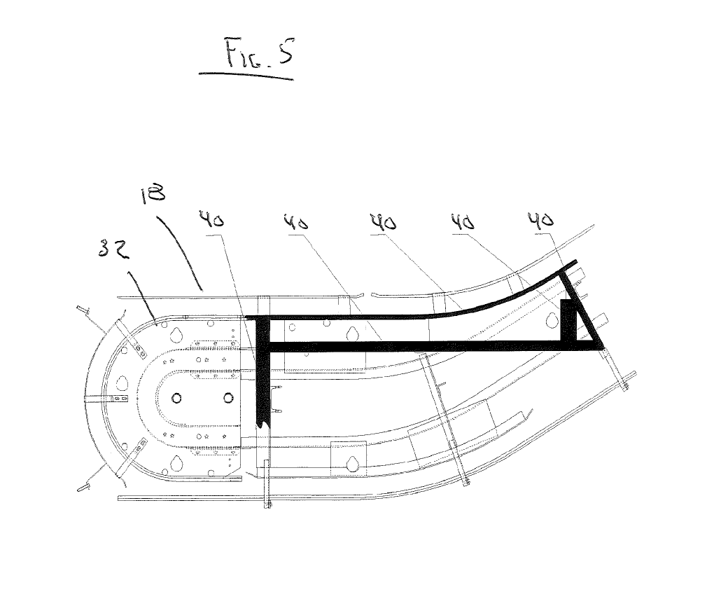

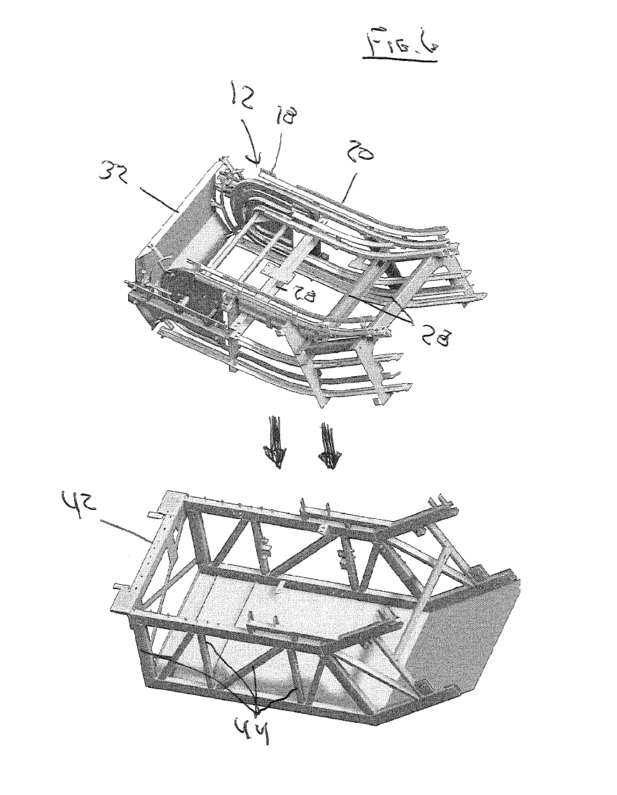

Referring now to FIG. 4, the lower support brackets 28 may be arranged to form a first lower frame 34. The first lower frame 34 is located in a substantially horizontal plane in the lower landing assembly 12 and includes two lower support brackets 28 extending across the lower landing assembly 12 and two side supports 36 secured to and extending between the two lower support brackets 28 thus forming the first lower frame 34. The structure may be secured together by any suitable means, for example, welding or threaded fasteners. Referring to FIG. 5, the lower landing assembly 12 also may include two second lower frames 38. Each second lower frame 38 is positioned in a substantially vertical plane and includes one or more second lower frame members 40 assembled via welding, threaded fasteners, or the like, into the second lower frames 38. The first lower frame 34 extends between the second lower frames 38.

The lower landing assembly 12 is then installed as a unit into a lower truss assembly 42, as shown in FIG. 6. The lower truss assembly 42 includes an array of lower truss members 44 extending along the lateral sides 22, 24 of the lower landing assembly 12. Assembling the lower landing assembly 12 as a modular unit into the lower truss assembly 42 reduces on-site assembly time of the lower landing assembly over prior methods where components are installed individually directly to the lower truss assembly 42. Further, since bolts are utilized to install the lower profile tracks 20 and lower tension carriage 32 to the lower support brackets 28, rather than having them welded, the positions of the lower profile tracks 28 have improved adjustability to enable improved performance of the escalator system 10.

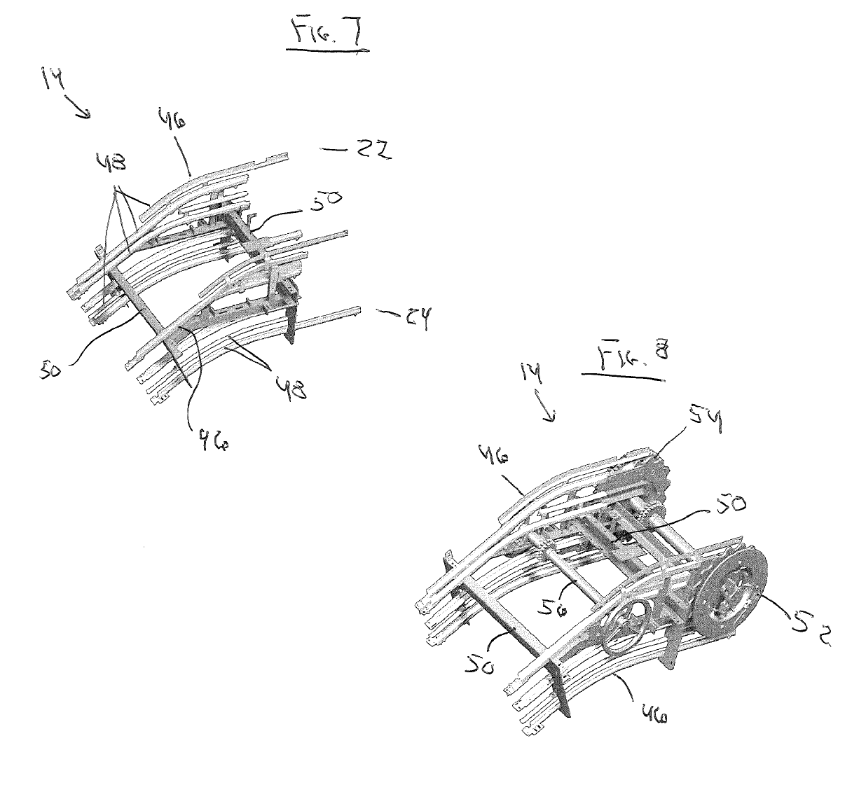

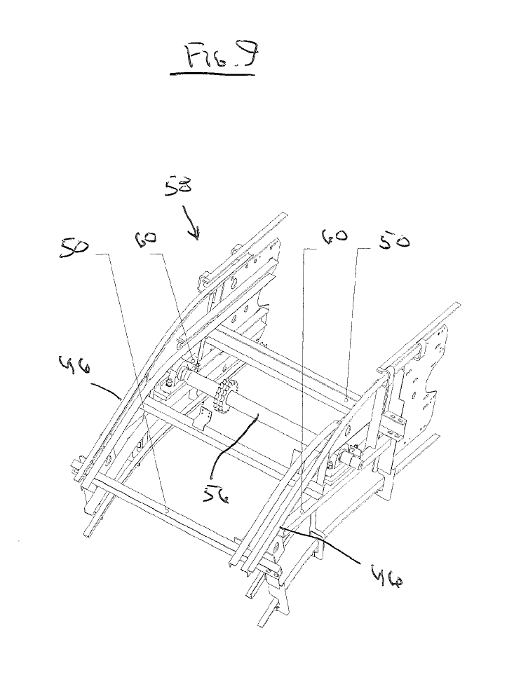

As shown in FIG. 7, a similar assembly method is applied to the upper landing assembly 14. The upper landing assembly 14 includes an upper track set 46 made up of a plurality of individual upper profile tracks 48. The upper profile tracks 48 are secured to one or more upper support brackets 50 by, for example, threaded mechanical fasteners such as bolts (not shown). The upper support brackets 50 span from the first lateral side 22 to the second lateral side 24 such that both upper track sets 46 are affixed to the upper support brackets 50 and accurately positioned relative to each other. Referring to FIG. 8, the upper landing assembly 14 further includes a main drive 52 which drives the escalator 10. The main drive 52 is secured to the upper track sets 46 via a main drive turnaround 54. Further, in some embodiments, a handrail drive 56 is secured in the upper landing assembly 14 at the upper track set 46. The upper track sets 46, main drive 52 and handrail drive 56 are secured to the upper support brackets 50 such that the upper track sets 46, upper support brackets 50, main drive 52 and handrail drive 56 form a single unitary upper landing assembly 14.

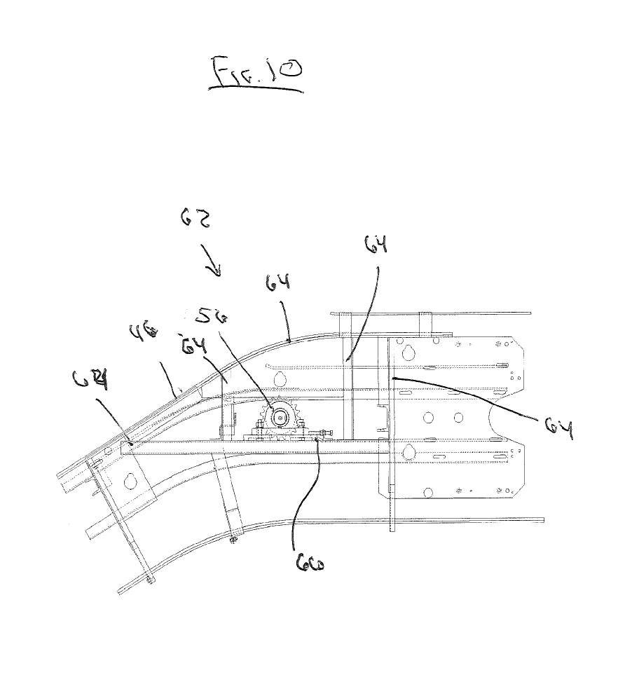

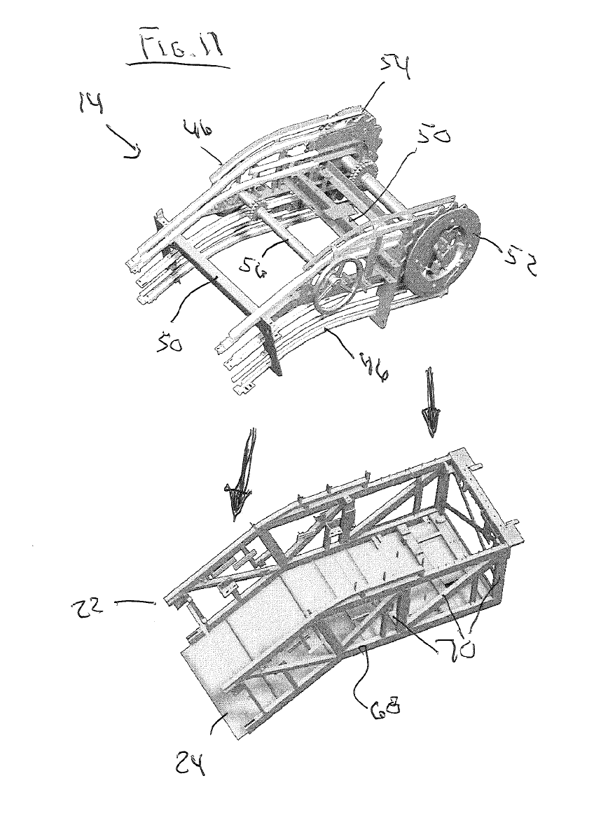

Referring now to FIG. 9, the upper support brackets 50 may be arranged to form a first upper frame 58. The first upper frame 58 is located in a substantially horizontal plane in the upper landing assembly 14 and includes two upper support brackets 50 extending across the upper landing assembly 14 and two upper side supports 60 secured to and extending between the two upper support brackets 50 thus forming the first upper frame 58. The structure may be secured together by any suitable means, for example, welding or threaded fasteners. Referring to FIG. 10, the upper landing assembly 14 also may include two second upper frames 62. Each second upper frame 62 is positioned in a substantially vertical plane and includes one or more second upper frame members 64 assembled via welding, threaded fasteners, or the like, into the second upper frames 62. The second upper frames 62 are positioned substantially vertically and the first upper frame 58 (not shown in FIG. 10) extends therebetween.

In some embodiments, a handrail drive plate 66 is provided spanning the second upper frames 62 and the handrail drive 56 is secured thereto. In some embodiments, a mounting hole (not shown) in the handrail drive plate 66 is slotted to allow for adjustment of a position of the handrail drive 56.

The upper landing assembly 14 is then installed as a unit into an upper truss assembly 68, as shown in FIG. 11. The upper truss assembly 68 includes an array of upper truss members 70 extending along the lateral sides 22, 24 of the upper landing assembly 14. Assembling the upper landing assembly 14 as a modular unit into the upper truss assembly 68 reduces on-site assembly time of the upper landing assembly 14 over prior methods where components are installed individually directly to the upper truss assembly 68. Further, since bolts are utilized to install the upper profile tracks 48 to the upper support brackets 50, rather than having them welded, the positions of the upper profile tracks 48 have improved adjustability to enable improved performance of the escalator system 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for assembling a drive system for an escalator system comprising:
securing one or more track sets extending along a path of the escalator to one or more support members extending at least partially across a width of the escalator system;
securing a drive member to the one or more support members such that the drive member is operably connected to the one or more track sets; and
installing the one or more track sets, the one or more support members and the drive member into the escalator system as a unit.

2. The method of claim 1, further comprising securing the one or more track sets to the one or more support members with one or more mechanical fasteners.

3. The method of claim 1, further comprising installing the one or more track sets, the one or more support members and the drive member into the escalator system as a unit with one or more mechanical fasteners.

4. The method of claim 1, further comprising installing the one or more track sets, the one or more support members and the drive member into a support truss assembly of the escalator system.

5. The method of claim 1, wherein the one or more track sets, the one or more support members and the drive member comprise a lower landing assembly of the escalator system.

6. The method of claim 5, wherein the drive member is a lower tension carriage.

7. The method of claim 1, wherein the one or more track sets, the one or more support members and the drive member comprise an upper landing assembly of the escalator system.

8. The method of claim 7, wherein the drive member is an escalator main drive.

9. The method of claim 7, wherein the drive member is an escalator handrail drive.

10. An escalator drive system comprising:
one or more track sets extending along a path of an escalator system;
a drive member operably connected to the one or more track sets; and
one or more support members extending at least partially across a width of the escalator system and secured to the one or more track sets and/or the drive member, such that the one or more track sets, the one or more support members and the drive member are installable into the escalator system as a unit.

11. The escalator drive system of claim 10, wherein the one or more track sets are secured to the one or more support members with one or more mechanical fasteners.

12. The escalator drive system of claim 10, wherein the one or more track sets, the drive member and the one or more support members are installable as a unit into a support truss assembly of the escalator system.

13. The escalator drive system of claim 10, wherein the one or more track sets, the one or more support members and the drive member comprise a lower landing assembly of the escalator system.

14. The escalator drive system of claim 13, wherein the drive member is a lower tension carriage.

15. The escalator drive system of claim 10, wherein the one or more track sets, the one or more support members and the drive member comprise an upper landing assembly of the escalator system.

16. The escalator drive system of claim 15, wherein the drive member is an escalator main drive.

17. The escalator drive system of claim 15, wherein the drive member is an escalator handrail drive.
